(19) United States
(12) Patent Application Publication
(10) Pub. No.: US 2002/0043594 A1
(43) Pub. Date: Apr. 18, 2002

(54) Stand for flexible conduit

(76) Inventor: Joseph M. Kiry, St. Louis, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/841,583

(22) Filed: Apr. 24, 2001

Related U.S. Application Data
(60) Provisional application No. 60/199,553, filed on Apr. 25, 2000.

(51) Int. Cl. B05B 15/06; A47G 29/00

(52) U.S. Cl. 248/80

(57) ABSTRACT

A stand for coiling and storing a length of flexible conduit, such as hose, electrical cord, etc., to hold the flexible conduit securely and inhibit the flexible conduit from wear and damage due to frequent contact with the stand. The stand comprises a substantially vertical post with an upper arm and a lower arm extending laterally outwardly from the post in a general forward direction. The arms are spaced apart vertically from one another, the upper arm extending forwardly and upwardly and the lower arm extending forwardly and downwardly. The post and the upper and lower arms form two opposing U-shaped cradles for receiving and storing a coiled length of flexible conduit. Embodiments of the stand are attachable to various surfaces, including a wall, a horizontal support surface or a section of ground. Cushioning sleeves encase the arms, thereby increasing the radius of the arms and providing a cushioning layer between the arms and the flexible conduit.

This application claims the benefit of U.S. Provisional Application No. 60/199,553, filed Apr. 25, 2000, which is hereby incorporated by reference in its entirety.

### BACKGROUND OF THE INVENTION

This invention relates to hose stands, and more particularly to a stand for storing a length of water, or garden, hose. The stand is especially adapted for coiling and storing a length of hose in an efficient and orderly manner. The stand may be useful for commercial and residential applications, and it may have coiling and storing uses other than for water hose, such as for electrical cord, rope, vacuum hose, etc.

Previous devices for storage of hose and other flexible conduit suffer from various drawbacks. These drawbacks include complexity of design and a lack of a cushioning layer to support the conduit to inhibit wear and damage. For example, U.S. Pat. No. 5,806,814 (White) discloses a complex water hose storage device 10 that includes multiple mounting flanges 14, 16, 18, structural members 32, 33, 38, 40, arms 24, 26, posts 34, 36 and elbows 46, 48, 50. Such a storage device with many parts is expensive and time-consuming to manufacture, assemble and install. The device also requires multiple attachment surfaces for mounting. White also discloses rotatable hose support members 28, 30 preferably manufactured from a hard material, such as polyvinyl chloride (PVC). These provide no cushioning layer to inhibit hose wear and damage from frequent rubbing contact with the stand. Other storage devices suffer from similar drawbacks.

### SUMMARY OF THE INVENTION

Among the several objects and features of the present invention may be noted the provision of a stand which is economical to manufacture; the provision of a stand which is easily and readily attachable to several different surfaces; the provision of a stand which is attachable to a wall by a single, centrally-disposed wall support; the provision of a stand which is attachable to a support surface, such as a concrete slab, by a single post; the provision of a stand that includes a vertical post and a L-shaped support that may be driven into the ground; and the provision of a stand that includes a cushioning layer to inhibit the flexible conduit from excessive wear and damage due to contact with the stand.

Generally, a stand of the present invention for storing a length of flexible conduit comprises a substantially vertical post having a lower end engageable with a support surface and an upper end. The stand further comprises an upper arm and a lower arm extending laterally outwardly from the post in a general forward direction. The arms are spaced apart vertically from one another. The upper arm extends forwardly and upwardly from a horizontal orientation to a substantially vertical orientation and terminates in an upper end. The lower arm extends forwardly and downwardly from a horizontal orientation to a substantially vertical orientation and terminates in a lower end. The post and the upper and lower arms form two opposing U-shaped cradles for receiving and storing a coiled length of flexible conduit. The stand further comprises a wall support extending laterally rearwardly from the post for attachment to a wall.

In another embodiment of the present invention, the stand of the present invention comprises a substantially vertical post, an upper arm and a lower arm generally as set forth above. The stand further comprises a mounting plate attachable to the lower end of the post for securing the post to a support surface.

In yet another embodiment of the present invention, the stand comprises a substantially vertical post, an upper arm and a lower arm generally as set forth above. The lower end of the vertical post has a tapered point so the post may be driven into the ground. The stand further comprises an L-shaped support generally adjacent the lower end of the post having a horizontal leg extending laterally rearwardly from the post and a vertical leg extending down from the horizontal leg. The lower end of the vertical leg has a tapered point capable of being driven into the ground.

In another embodiment of the present invention, the stand comprises a substantially vertical post and an attachment means for securing the post to a fixed object. The stand further includes a pair of arms extending from the post for securing a length of flexible conduit and a pair of sleeves encasing the arms. The sleeves increase the radius of the arms and provide a cushioning layer between the arms and the flexible conduit.

Other objects and features of the present invention will be in part apparent and in part pointed out hereinafter.

### BRIEF DESCRIPTION OF THE DRAWINGS

FIG. 1 is a perspective of a stand of the present invention;

FIG. 2 is a perspective of a second embodiment of a stand; and

FIG. 3 is a perspective of a third embodiment of a stand.

Corresponding reference characters indicate corresponding parts throughout the several views of the drawings.

### DETAILED DESCRIPTION OF THE PREFERRED EMBODIMENTS

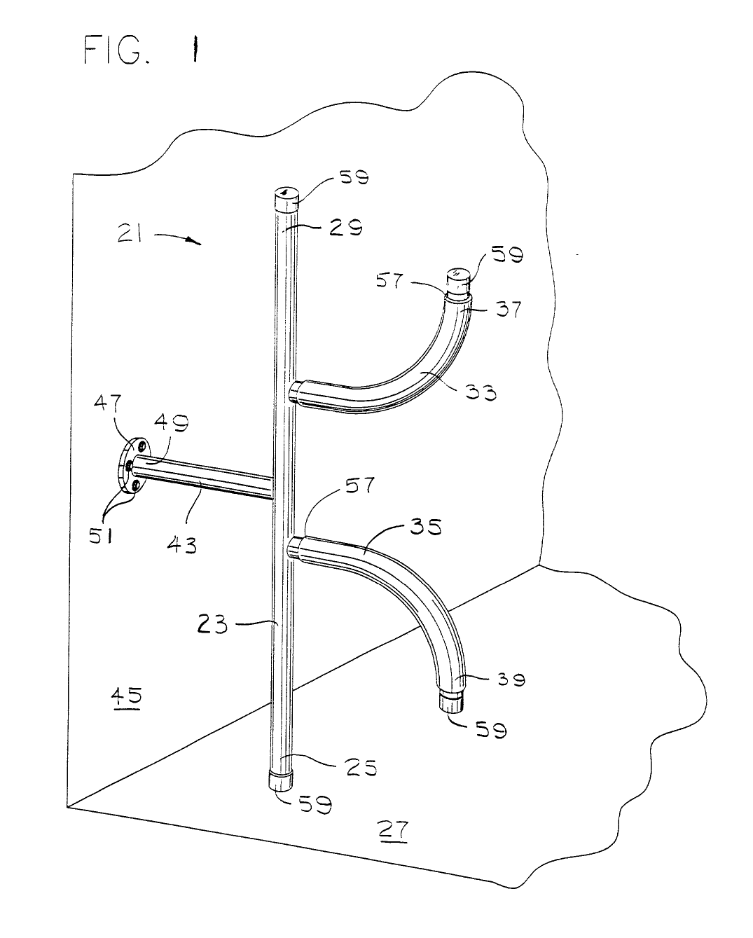

Referring now to FIG. 1, a stand of the preferred embodiment for storing a length of flexible conduit, such as hose, electrical cord, etc., is generally indicated at 21. The stand 21 comprises a vertical post 23 having a lower end 25 engageable with a support surface 27 and an upper end 29.

An upper arm 33 and a lower arm 35 extend laterally outwardly from the post 23 in a generally forward direction (FIG. 1). The upper arm 33 extends forwardly and upwardly from a horizontal orientation to a substantially vertical orientation, terminating in an upper end 37. Similarly, the lower arm 35 extends forwardly and downwardly from a horizontal to a substantially vertical orientation, terminating in a lower end 39. The two arms 33, 35 and post 23 combine to form two opposing, generally U-shaped cradles for receiving and storing a coiled length of flexible conduit (not shown).

The stand additionally comprises a wall support 43 for securing the post 23 to a wall 45. The wall support 43 extends laterally rearwardly from the post 23 and is generally cylindric in shape. A mounting plate 47 is secured (e.g., welded or threaded) to the rearward end 49 of the support 43. The mounting plate 47 has holes spaced about its perimeter for receiving common fasteners 51, such as nails or screws, for attaching the mounting plate to the wall 45.

In the preferred embodiment, the support 43, the post 23 and the arms 33, 35 are formed from tubular bar stock of a suitable material, for example steel. The members may have other shapes and/or be formed from other suitable materials without departing from the scope of the invention.

Sleeves 57 cover the upper and lower arms 33, 35 of the stand 21 to increase the radii of the arms and provide a cushioning layer between the arms and the conduit. The sleeves 57 are preferably formed from an elastomer, such as foam rubber. Other materials exhibiting similar characteristics may also be used without departing from the scope of the invention. An elastomeric sleeve may also cover the post 23 to protect the conduit further. In addition, caps 59 close the upper and lower ends of the post 25, 29 and the ends of the arms 37, 39. These caps 59 may screw onto threaded ends of the members or may press fit snugly onto the ends of the members.

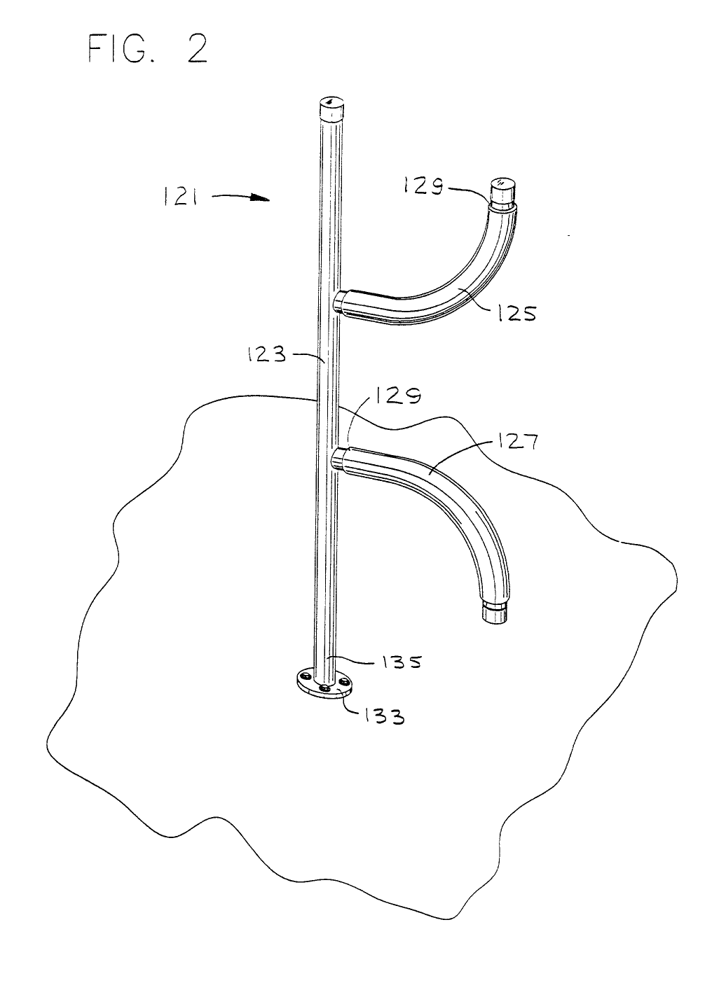

A second embodiment of the stand 121 is shown in FIG. 2. The stand 121 comprises a vertical post 123, an upper arm 125, a lower arm 127, and sleeves 129, all of which are similar in construction to the previous embodiment. The post 123 has a mounting plate 133 attachable to its lower end 135 for mounting the stand 121 in fixed position on a support surface 137 (e.g., a concrete slab). The mounting plate 133 is similar to the mounting plate of the first embodiment, having holes spaced about its perimeter for attachment of the mounting plate to the support surface with fasteners 139, such as screws or nails.

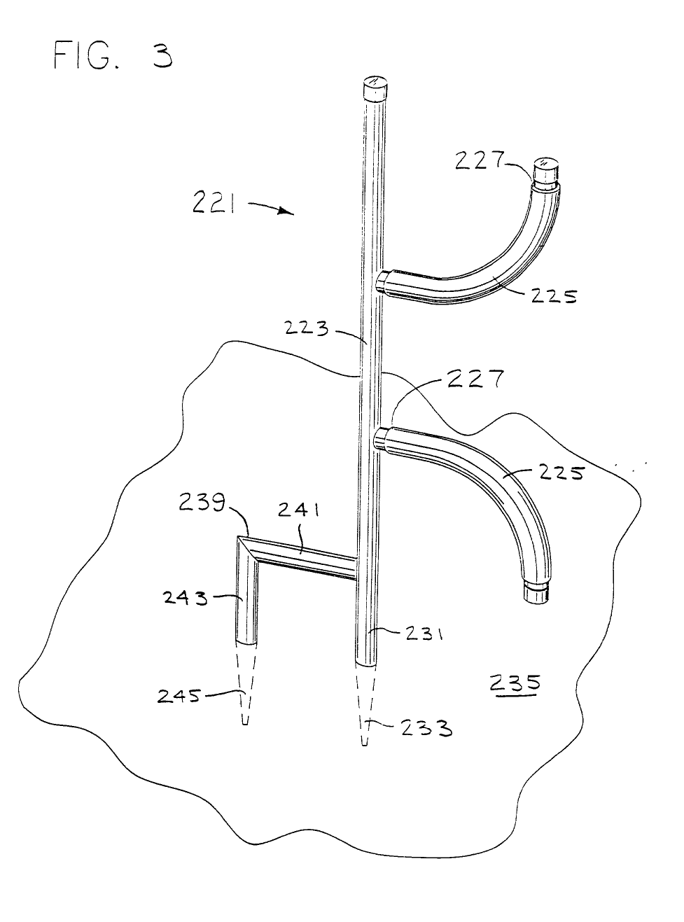

FIG. 3 shows a third embodiment of the stand 221 of the present invention. The stand 221 has a vertical post 223; a pair of arms 225, and a pair of sleeves 227 similar to the previous embodiments. The lower end 231 of the post 223 has a tapered point 233 so the post may be driven into the ground 235. Generally adjacent the lower end 231 of the post 223 is an anchor comprising an L-shaped support 239 having a horizontal leg 241 extending laterally rearwardly from the post and a vertical leg 243 extending down from the horizontal leg. The lower end of the vertical leg 243 also has a tapered point 245 capable of being driven into the ground 235. The L-shaped support 239 and tapered lower end 231 of the post 223 secure the stand 221 in the ground 235. The third embodiment allows the user to easily install the stand 221 at one location, remove the stand when finished, and relocate the stand to another location.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A stand for storing a length of flexible conduit, the stand comprising:
a substantially vertical post having a lower end engageable with a support surface and an upper end;
an upper arm and a lower arm extending laterally outwardly from the post in a general forward direction, the arms being spaced apart vertically from one another, the upper arm extending forwardly and upwardly from a horizontal orientation to a substantially vertical orientation and terminating in an upper end, the lower arm extending forwardly and downwardly from a horizontal orientation to a substantially vertical orientation and terminating in a lower end, such that the post and the upper and lower arms form two opposing U-shaped cradles for receiving and storing a coiled length of flexible conduit;
a wall support extending laterally rearwardly from the post for attachment to a wall.

2. A stand as set forth in claim 1 wherein the support, the post, and the arms are constructed of tubular bar stock of circular cross section.

3. A stand as set forth in claim 1 further comprising an upper sleeve encasing the upper arm and a lower sleeve encasing the lower arm, thereby increasing the radius of the arms and providing a cushioning layer between the arms and the flexible conduit.

4. A stand for storing a length of flexible conduit, the stand comprising:
a substantially vertical post having a lower end and an upper end;
an upper arm and a lower arm extending laterally outwardly from the post in a general forward direction, the arms being spaced apart vertically from one another, the upper arm extending forwardly and upwardly from a horizontal orientation to a substantially vertical orientation and terminating in an upper end, the lower arm extending forwardly and downwardly from a horizontal orientation to a substantially vertical orientation and terminating in a lower end, such that the post and the upper and lower arms form two opposing U-shaped cradles for receiving and storing a coiled length of flexible conduit; and
a mounting plate attachable to the lower end of the post for securing the post to a support surface.

5. A stand as set forth in claim 4 wherein the post and the arms are constructed of tubular bar stock of circular cross section.

6. A stand as set forth in claim 4 further comprising an upper sleeve encasing the upper arm and a lower sleeve encasing the lower arm, thereby increasing the radius of the arms and providing a cushioning layer between the arms and the flexible conduit.

7. A stand for storing a length of flexible conduit, the stand comprising:
a substantially vertical post having a lower end and an upper end, the lower end has a tapered point so the post may be driven into the ground;
an upper arm and a lower arm extending laterally outwardly from the post in a general forward direction, the arms being spaced apart vertically from one another, the upper arm extending forwardly and upwardly from a horizontal orientation to a substantially vertical orientation and terminating in an upper end, the lower arm extending forwardly and downwardly from a horizontal orientation to a substantially vertical orientation and terminating in a lower end, such that the post and the upper and lower arms form two opposing U-shaped cradles for receiving and storing a coiled length of flexible conduit; and
an L-shaped support generally adjacent the lower end of the post having a horizontal leg extending laterally rearwardly from the post and a vertical leg extending down from the horizontal leg, the lower end of the vertical leg has a tapered point so that it too may be driven into the ground.

8. A stand as set forth in claim 7 wherein the post, the arms, and the L-shaped support are constructed of tubular bar stock of circular cross section.

9. A stand as set forth in claim 7 further comprising an upper sleeve encasing the upper arm and a lower sleeve encasing the lower arm, thereby increasing the radius of the arms and providing a cushioning layer between the arms and the flexible conduit.

10. A stand for storing a length of flexible conduit, the stand comprising:
a substantially vertical post;
an attachment means for securing the post to a fixed object;
a pair of arms extending from the post for securing a length of flexible conduit; and
a pair of sleeves encasing the arms, thereby increasing the radius of the arms and providing a cushioning layer between the arms and the flexible conduit.
